(19) United States
(12) Patent Application Publication
(10) Pub. No.: US 2015/0058053 A1
(43) Pub. Date: Feb. 26, 2015

(54) SHIFTING A GROUP OF TASKS ALONG A TIMELINE

(71) Applicant: Oracle International Corporation, Redwood Shores, CA (US)

(72) Inventors: Niladri Sekhar De, Hyderabad (IN); Srinivasu Dudala, Hyderabad (IN)

(73) Assignee: Oracle International Corporation, Redwood Shores, CA (US)

(21) Appl. No.: 13/970,612

(22) Filed: Aug. 20, 2013

(51) Int. Cl. G06Q 10/06

(52) U.S. Cl. CPC G06Q 10/06311
USPC 705/7.13

(57) ABSTRACT

An aspect of the present disclosure facilitates the shifting of a group of tasks along a timeline. In one embodiment, multiple tasks are sent for display along a timeline, with each task having a start time and an end time respectively equaling an original start value and an original end value along the timeline. In response to receiving data indicating a group of tasks and an offset, a new start value and a new end value for each of the tasks in the group is computed based on the offset. The start time and end time of each of the tasks in the group is set respectively to the computed new start value and new end value. The display of the timeline is updated (by resending the tasks) with the start time and end time of each task of the group set to the newly computed values. Thus, the received group of tasks is shifted along the timeline by the received offset.

### BACKGROUND OF THE DISCLOSURE

1. Technical Field

The present disclosure relates to task management systems and more specifically to shifting a group of tasks along a timeline.

2. Related Art

A task generally refers to an activity to be performed. There are often situations when organizations are required to perform multiple related tasks, for example, as a part of a project. The tasks may be related for the overall objective, or due to the tasks being required to be performed in sequence, parallel, etc.

A timeline provides a common reference to indicate relevant time instances (dates and times) such as start and end time instances, corresponding to various tasks. The tasks are represented along the timeline based on various factors such as the effort (e.g., in terms of duration) required for performing each task, the availablility of resources for performance of the tasks, the relationships among the tasks, etc., as is well known in the relevant arts.

There are often situations where it may be desirable to shift a group of tasks along the timeline. For example, the group of tasks may relate to a portion of a project that has been delayed, unplanned disruptions to the performance of some of the group of tasks, opportunity to further optimize/reduce the time to reach the overall objective, etc.

It is is generally desirable that such shifting of a group of tasks along a timeline be simplified.

### BRIEF DESCRIPTION OF THE DRAWINGS

Example embodiments of the present disclosure will be described with reference to the accompanying drawings briefly described below.

FIG. 1 is a block diagram illustrating an example environment in which several aspects of the present disclosure can be implemented.

FIG. 2 is a flow chart illustrating the manner in which shifting of a group of tasks along a timeline is simplified in one embodiment.

FIGS. 3A-3D together illustrates an example approach to shifting of a group of tasks along a timeline in an embodiment.

FIGS. 4A and 4B together illustrates the manner in which management data is maintained in an embodiment.

FIG. 5 is a block diagram illustrating the details of a digital processing system in which various aspects of the present disclosure are operative by execution of appropriate executable modules.

In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE EMBODIMENTS OF THE DISCLOSURE

### 1. Overview

An aspect of the present disclosure facilitates the shifting of a group of tasks along a timeline. In one embodiment, multiple tasks are sent for display along a timeline, with each task having a start time and an end time respectively equaling an original start value and an original end value along the timeline. In response to receiving data indicating a group of tasks and an offset, a new start value and a new end value for each of the tasks in the group is computed based on the offset. The start time and end time of each of the tasks in the group is set respectively to the computed new start value and new end value. The display of the timeline is updated (by resending the tasks) with the start time and end time of each task of the group set to the newly computed values.

Thus, the received group of tasks is shifted along the timeline by the received offset. In one embodiment, the updating of the display is not performed tasks not contained in the received group of tasks.

According to another aspect of the present disclosure, a management data is maintained specifying for each of the tasks, a corresponding effort required to completing the task and a corresponding resource assigned to the task. The management data also indicates the availability of the resources assigned to the various tasks. Accordingly, the new start and end values for each task is computed based on the received offset and the availability of the resource assigned to the task, while ensuring that the effort for the task remains the same.

According to one aspect of the present disclosure, a management data indicates whether or not each of the tasks displayed along a timeline is completed. Accordingly, after receiving the data of above, the management data is inspected to identify the tasks that are already completed. The identified completed tasks are excluded from the group of tasks, and accordingly the above noted steps of setting and updating are not performed for the completed tasks.

According to yet another aspect of the present disclosure, a management data indicates a percentage of completion of each of the tasks displayed along a timeline. Accordingly, after receiving the data of above, the management data is inspected to identify the partially completed tasks by examining the management data. For each partially completed task, a corresponding pair of tasks respectively representing the completed and non-completed portions of the partially completed task is formed. The pair of tasks are then included in place of the partially completed task along the timeline, with the task representing the non-completed portion included in place of the partially completed task in the group of tasks. As such, the above noted setting and updating operations are performed for the non-completed portions of the partially completed tasks instead of the partially completed tasks.

According to an aspect of the present disclosure, a management data indicates the dependencies among the different tasks displayed along a timeline. Accordingly, after receiving the data of above, the management data is inspected to identify a dependency between a first task and a second task. In view of the identified dependency, the new start and end values of the first task is computed based on the received offset and at least one of the new start and end values of the second task according to the dependency.

According to one aspect of the present disclosure, a data indicating a group of tasks, an offset and a copy flag are received, with the copy flag indicating that a copy of the group of tasks is to be scheduled. In response, a new group of tasks representing a copy of the received group of tasks is added to the tasks displayed along a timeline. The new start and end values for each of the new group of tasks is computed based on the original start and end values of the received group of tasks, and the received offset. The start time and end time of each of the tasks in the new group is set respectively to the computed new start and end values. The display of the timeline is updated (by resending the tasks) with the start time and end time of each task of the new group set to the newly computed values. Accordingly, the timeline displays both of the received group of tasks and the new group of tasks.

Several aspects of the present disclosure are described below with reference to examples for illustration. However, one skilled in the relevant art will recognize that the disclosure can be practiced without one or more of the specific details or with other methods, components, materials and so forth. In other instances, well-known structures, materials, or operations are not shown in detail to avoid obscuring the features of the disclosure. Furthermore, the features/aspects described can be practiced in various combinations, though only some of the combinations are described herein for conciseness.

### 2. Example Environment

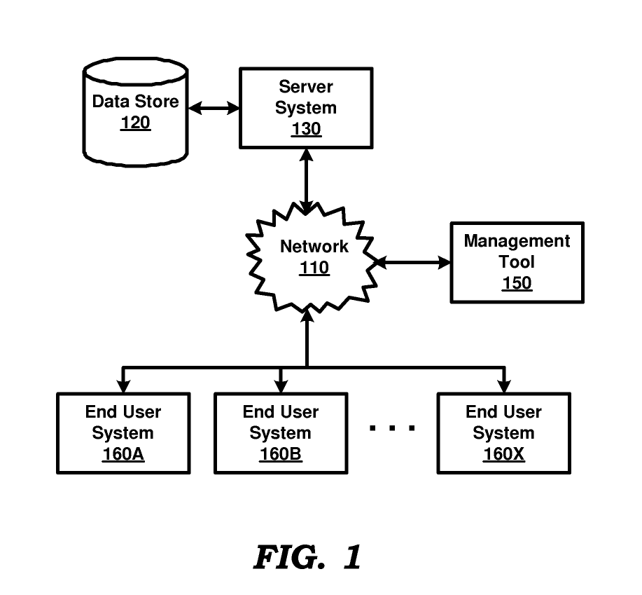

FIG. 1 is a block diagram illustrating an example environment in which several aspects of the present invention can be implemented. The block diagram is shown containing network 110, data store 120, server system 130, management tool 150 and end user systems 160A-160X.

Merely for illustration, only representative number/type of systems is shown in the Figure. Many environments often contain many more systems, both in number and type, depending on the purpose for which the environment is designed. Each system/device of FIG. 1 is described below in further detail.

Network 110 provides connectivity between server system 130, management tool 150 and end user systems 160A-160X, and may be implemented using protocols such as Transmission Control Protocol (TCP) and/or Internet Protocol (IP), well known in the relevant arts. In general, in TCP/IP environments, an IP packet is used as a basic unit of transport, with the source address being set to the IP address assigned to the source system from which the packet originates and the destination address set to the IP address of the destination system to which the packet is to be eventually delivered.

A (IP) packet is said to be directed to a destination system when the destination IP address of the packet is set to the (IP) address of the destination system, such that the packet is eventually delivered to the destination system by network 110. When the packet contains content such as port numbers, which specifies the destination application, the packet may be said to be directed to such application as well. The destination system may be required to keep the corresponding port numbers available/open, and process the packets with the corresponding destination ports. Network 110 may be implemented using any combination of wire-based or wireless mediums.

Data store 120 represents a non-volatile (persistent) storage facilitating storage and retrieval of data (such as the original/new values of the start and end times of the tasks, the resource assigned to each task, the availability of each of the resources, etc.) by applications executing in server system 130. Data store 120 may be implemented as a corresponding database server using relational database technologies and accordingly provide storage and retrieval of data using structured queries such as SQL (Structured Query Language). Alternatively, data store 120 may be implemented as a corresponding file server providing storage and retrieval of data in the form of files organized as one or more directories, as is well known in the relevant arts.

Server system 130 represents a server, such as a web/application server, executing applications (such as project/task management applications that enables users to manage tasks) capable of processing (user) requests received from users using one of end user systems 160A-160X. The server system may use data stored internally (for example, in a non-volatile storage/hard disk within the system), external data (for example, stored in data stores such as 120) and/or data received from external sources (e.g., from the user) in processing of the user requests. The server system then sends the result of processing of the user requests to the requesting end user system (one of 160A-160X).

Each of end user systems 160A-160X represents a system such as a personal computer, workstation, mobile station, mobile phones, computing tablets, etc., used by users to generate (user) requests directed to applications executing in server system 130. The user requests may be generated using appropriate user interfaces (for example, web pages provided by applications executing in server system 130). The user requests may be sent by a manager for managing the various tasks, assigning the resources to tasks, etc. or by an end user to determine the specific tasks assigned to him/her (the resource), the values of the start and end times of the assigned tasks, etc.

As noted in the Background section, a manager/user using one of end user systems 160A-160X may wish to shift a group of tasks due to reasons such as delay in the start of a project containing the group, for reassigning the group to another resource available at a later time, etc. In one prior approach, the manager is required to manually move each of the tasks in the group, by specifying the values for the start and end times for each of the task. It may be appreciated that such manual movement of the tasks even for a small group (e.g., having 10-50 tasks) may be laborious, time consuming and prone to errors (e.g., some of the dependencies among the tasks may not be preserved after moving).

Management tool 150, provided according to several aspects of the present invention, simplifies the shifting of a group of tasks along a timeline, while overcoming at least some of the challenges noted above. Management tool 150 may be implemented within a separate digital processing system, or provided within server system 130. Management tool 150 may be implemented based on hardware components such as processor(s) and memory storage(s), executing the appropriate instructions. The manner in which management tool 150 may simplify the shifting of a group of tasks is described below with examples.

### 3. Shifting of a Group of Tasks Along a Timeline

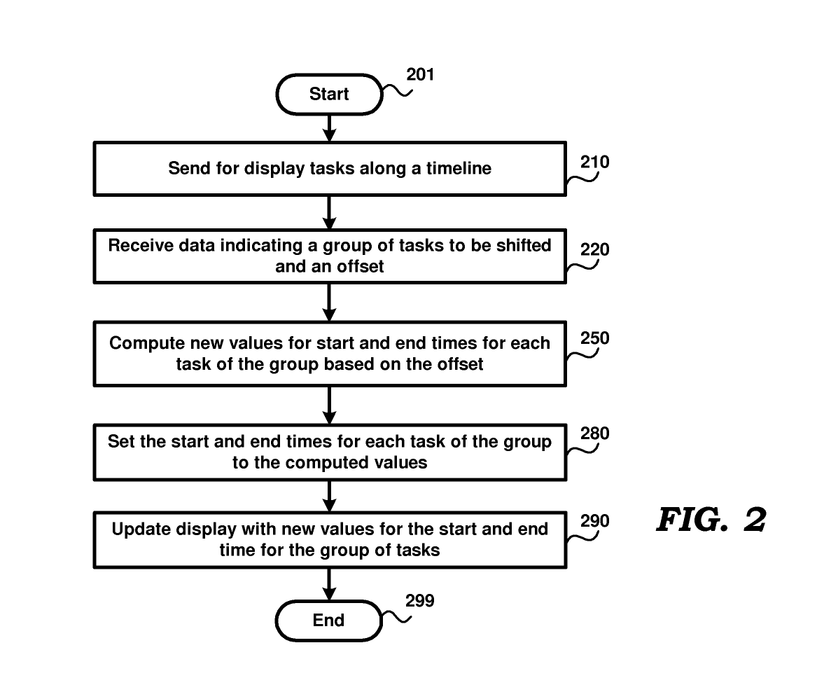

FIG. 2 is a flow chart illustrating the manner in which shifting of a group of tasks along a timeline is simplified according to an aspect of the present invention. The flowchart is described with respect to the systems of FIG. 1, in particular, management tool 150, merely for illustration. However, the features can be implemented in other systems and environments also without departing from the scope and spirit of various aspects of the present invention, as will be apparent to one skilled in the relevant arts by reading the disclosure provided herein.

In addition, some of the steps may be performed in a different sequence than that depicted below, as suited to the specific environment, as will be apparent to one skilled in the relevant arts. Many of such implementations are contemplated to be covered by several aspects of the present invention. The flow chart begins in step 201, in which control immediately passes to step 210.

In step 210, management tool 150 sends for display, various tasks along a timeline, with each task having a start time and an end time respectively equaling an original start value and an original end value along the timeline. The tasks may be sent for display in response to a request received from a user using one of end user systems 160A-160X. The tasks and the timeline may then be displayed on a display unit (not shown in FIG. 1) associated with the requesting end user system.

In step 220, management tool 150 receives data indicating a group of tasks to be shifted and an offset. A user may select each task of the group of the tasks using a suitable user interface provided on one of end user systems 160A-160X. Alternatively, the tasks in the group may be indicated by specifying the unique identifiers of the tasks. The offset may be provided as the number of days or hours (in general, duration) by which each of the tasks is to be shifted or as a new start time instance for the earliest task in the group of tasks (with the other tasks moved correspondingly).

In step 250, management tool 150 computes corresponding new values for the start time and end time of each tasks of the received group based on the received offset (and also on the original values for the start and end time). The computation may be performed in a known way, based on whether the offset is a number or a new value for the start time, as will be apparent to one skilled in the relevant arts by reading the disclosure herein.

In step 280, management tool 150 sets the start and end times of each task of the group to the computed new start and end values respectively. In step 290, management tool 150 updates (by resending for display) the timeline with the new values for the start and end time for the group of tasks. Accordingly, the timeline may thereafter display the group of tasks at the newly computed start and end times, reflecting the shifting of the group of tasks by the received offset. The flow chart ends in step 299.

Thus, by computing and setting a group of tasks based on received offset and other factors (such as effort required, availability of the resource, dependencies, etc.), a user/manager is relieved of the burden on manually shifting the group of tasks. In addition, since steps 250, 280 and 290 are performed only for each of the received group of tasks, the overheads associated with processing the shifting of tasks is also reduced.

The manner in which management tool 150 simplifies the shifting of a group of tasks along a timeline according to the steps of FIG. 2 is illustrated below with examples.

### 4. Illustrative Examples

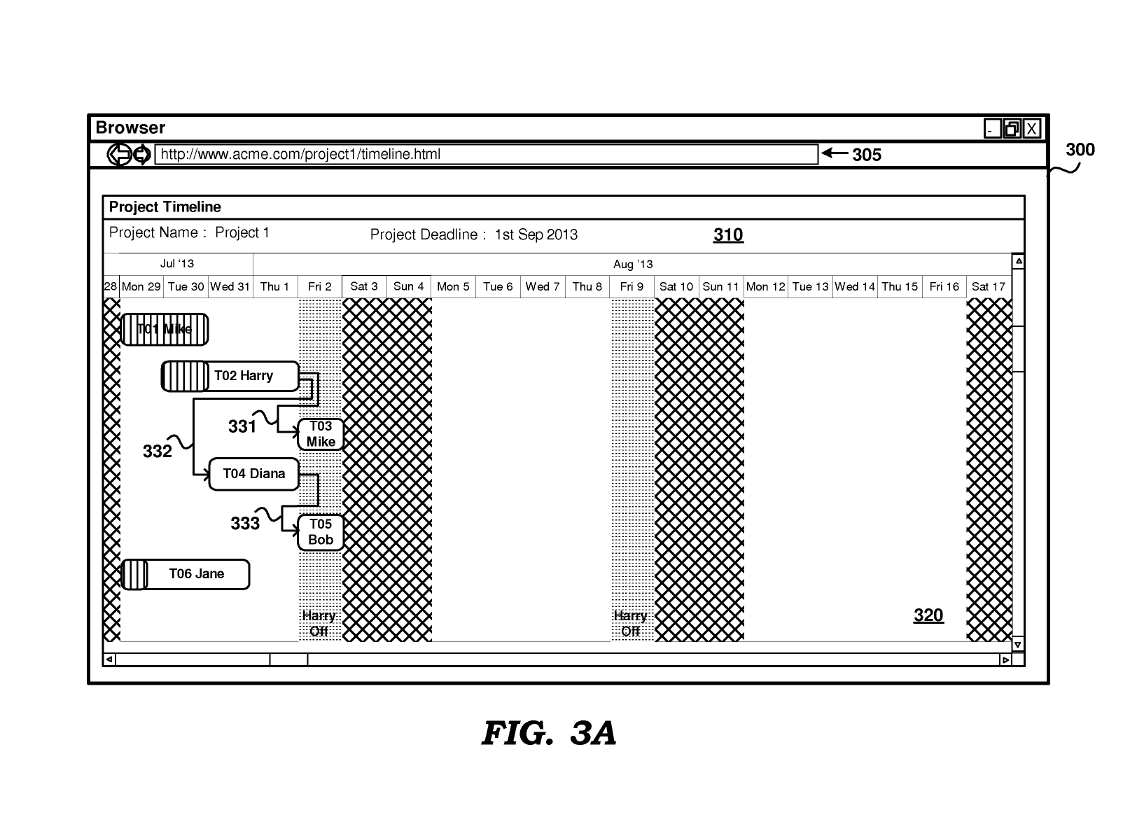

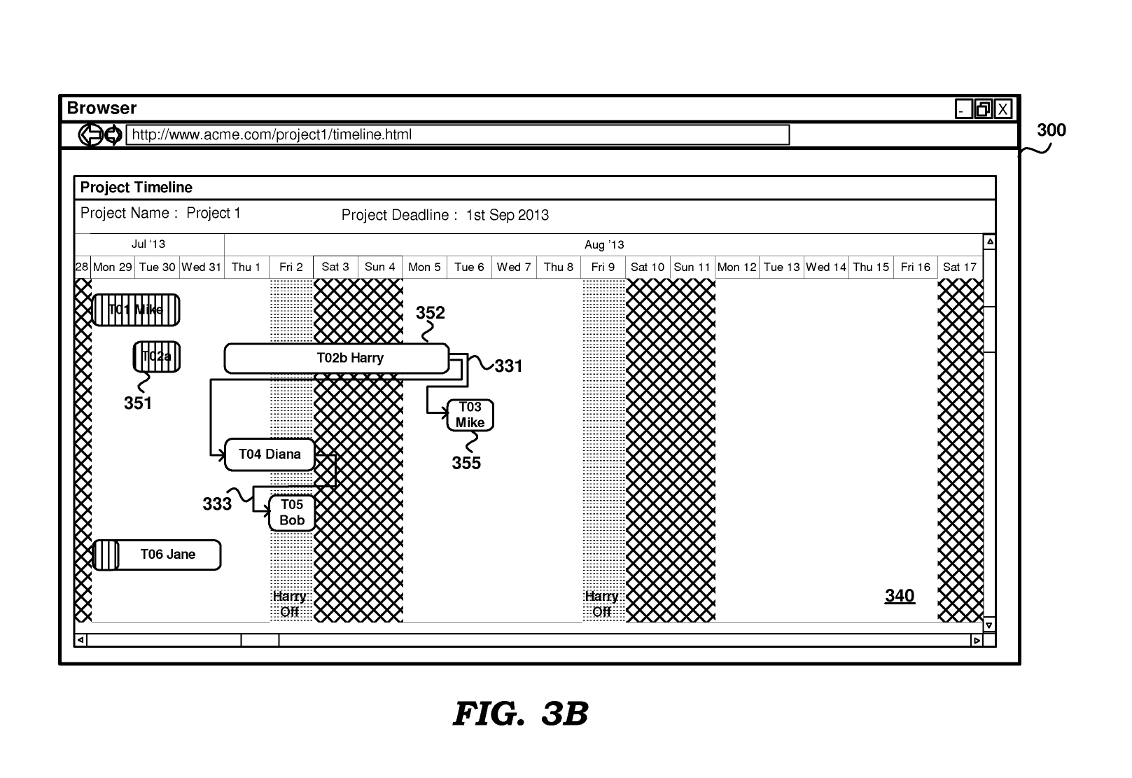

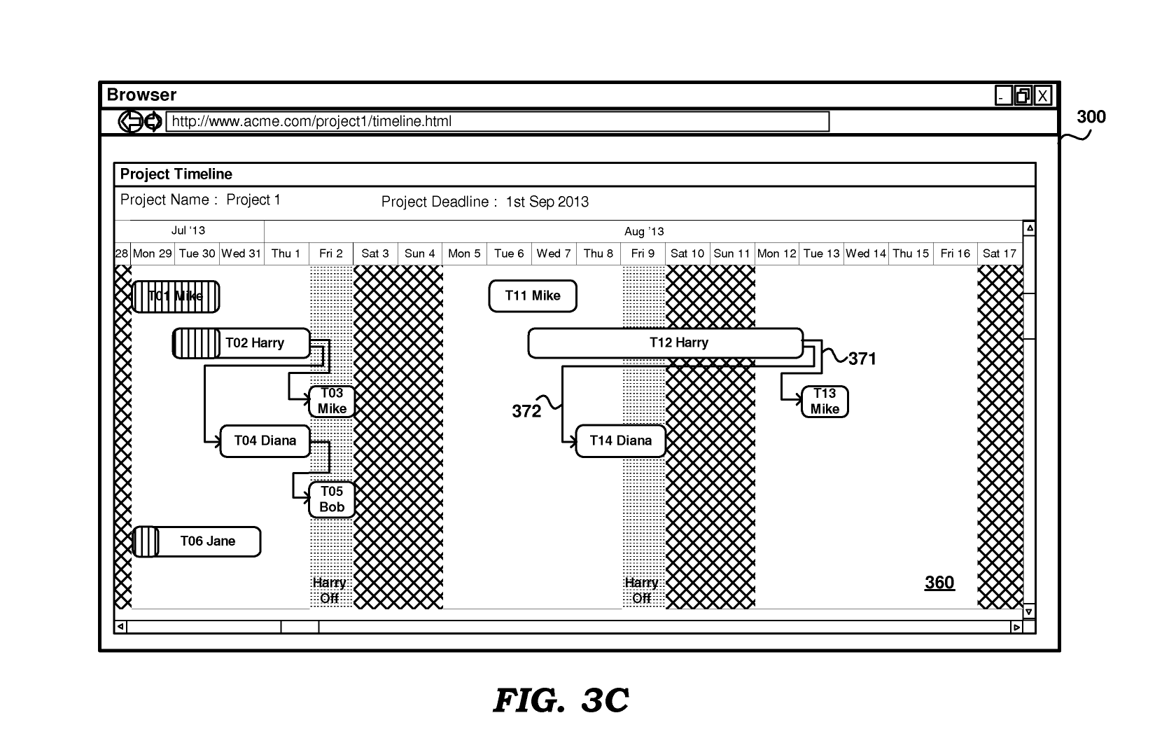

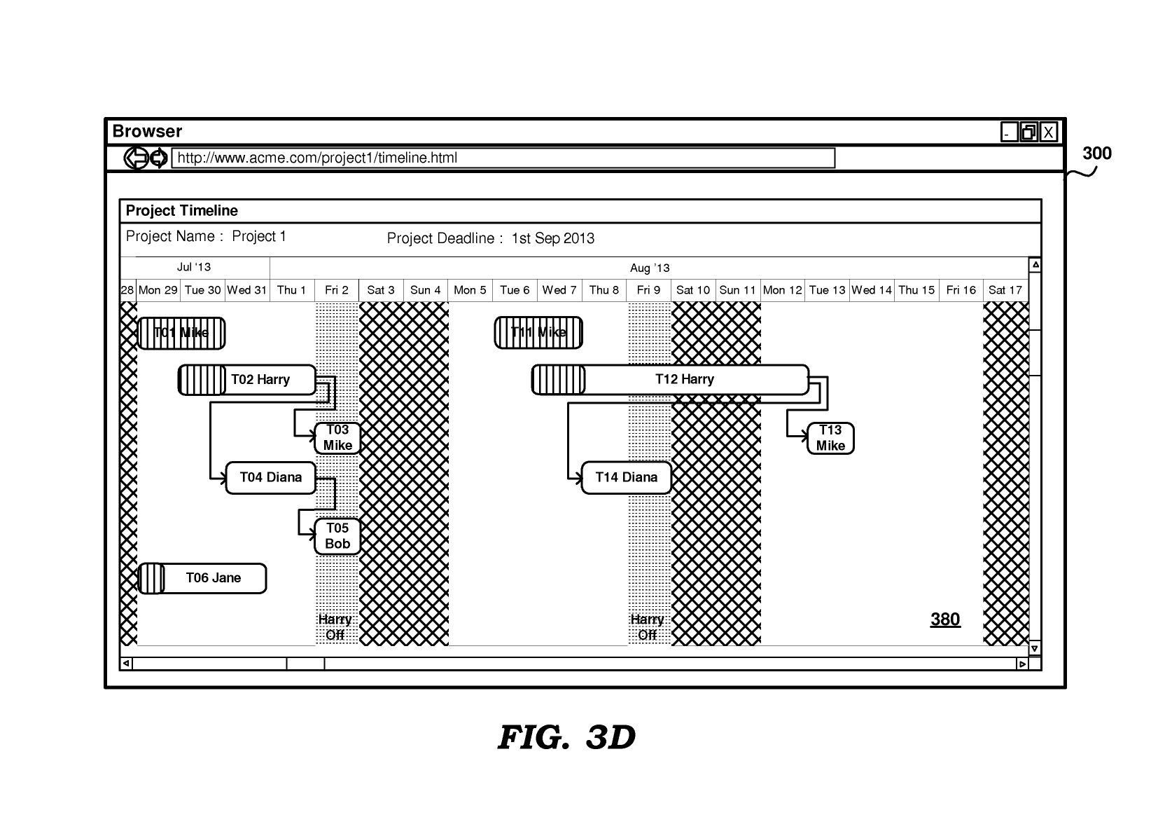

FIGS. 3A-3D together illustrates the manner in which shifting of a group of tasks along a timeline is simplified in one embodiment. Display area 300 of FIGS. 3A-3D depicts a portion of a user interface provided on a display unit (not shown in FIG. 1) associated one of end user systems 160A-160X (assumed to be 160A for illustration) or management tool 150. In one embodiment, display area 300 corresponds to a webpage accessed by the users using a browser in response to sending a request (including an identifier of the webpage, as indicated by the text in display area 305) from end user system 160A to management tool 150. The web page is received from management tool 150 prior to being displayed (using the browser) on the display unit.

Display area 310 of FIGS. 3A-3D indicates that the details of a project named “Project 1” having a project deadline of “1-Sep-2013” is being displayed in the user interface. It should be noted that several features of the present disclosure are described below with respect to the tasks of a project, for illustration. However, in alternative embodiments, the tasks displayed on the timeline may not form part of a project and may be any set of freeform unstructured tasks/activities that are required to be managed.

Referring to FIG. 3A, display area 320 provides a timeline of the various tasks in the project. In display area 320, a timeline indicating the various days of interest is shown displayed along the horizontal direction. The timeline is shown indicating the months (such as “Jul '13” and “Aug '13”) and the corresponding days (Monday, Tuesday, etc.) of interest in each of the months. It may be observed that common non-working days such as Saturdays and Sundays are shown as cross-hatched regions to indicate all the resources are not available during such days.

Furthermore, specific non-working days (such as “Fri 2” and “Fri 9”) of a specific resource “Harry” are also shown as dotted regions (marked as “Harry Off”) indicating that the specific resource is not available during the marked days. It is assumed that the specific resource is available on all the other days (excluding the common and specific non-working days). Though not shown, it may be appreciated that the non-working days (and correspondingly, the availability) for other resources such as “Mike”, “Bob”, etc. may be similarly represented on the timeline using different shaded regions, colors, etc. as will be apparent to one skilled in the relevant arts.

Display area 320 also displays the various tasks of the project below the timeline. Each task is shown in the form of a rounded rectangle with the name of the task (such as “T01”, “T02” etc.) and the name of the resource (such as “Mike”, “Harry”, etc.) assigned to the task shown in the middle of the rectangle. Each rectangle is shown between the corresponding (original) values of the start and end times of the task. The values of the start and end times of a task indicates the planned date/time at which the task is to be respectively started and completed. The width (along the horizontal direction) of the rectangle indicates the duration of the corresponding task (in other words, the effort required for the task). Tasks T01 and T06 (shown as having the same value for the start time) represent tasks that are to be performed simultaneously/in parallel by multiple resources.

It may be appreciated that tasks T01 and T06 represent earlier tasks (having no dependencies), while tasks T02 and T03 represent later tasks that may be dependent on the earlier tasks. Each of dependencies 331-333 (shown in solid lines) represents a Finish-to-Start dependency, indicating that the next/dependent task (such as T03, T04 and T05) cannot be started until the previous corresponding task (such as T02, T02 and T04) has finished/completed.

It may be observed that while the values for the start and end times of the other tasks are consistent with the corresponding dependency (331 and 333), the values shown for task T04 violates (does not satisfy) the Finish-to-Start dependency 332. Furthermore, though not shown, various other types of dependencies may exist between two tasks (A and B), such as Finish-to-Finish dependency indicating that task B cannot finish before task A is finished, Start-to-Start dependency indicating that task B cannot start before task A starts, and Start-to-Finish dependency indicating that task B cannot finish before task A starts, and may be correspondingly represented in display area 320.

Thus, the interface of FIG. 3A depicts various tasks of a project and the corresponding dependencies existing among the tasks. Management tool 150 may be requested to shift a group of tasks along the timeline shown in display area 320. Such a request may be received in response to a user selecting/clicking the desired tasks to be included in the group, selecting a button (not shown in display area 300) to indicate that the selected group of tasks are to be shifted, and then specifying the offset (for example, in a pop-up window displayed in response to selecting the button) by which the selected group of tasks are to be shifted.

Alternatively, a user/manager after selecting the desired group of tasks may use a mouse like device to drag and drop the selected group to a new location in the timeline. In response to the drag and drop action, management tool 150 determines that the new location of the earliest task as the offset by which the selected group of tasks are to be shifted. The other tasks in the selected groups are then shifted corresponding to the change in the value of the start times of the earliest task.

The description is continued assuming that the user has selected tasks T01, T02, T03 and T04 as the selected group and has indicated that group of tasks are to be shifted/delayed by a day. The manner in which management tool 150 computes new values for the start and end times for each of the selected/ received group of tasks is described below with examples.

### 5. Computing New Start and End Values

In response to receiving the selected group of tasks, management tool 150 first inspects a management data (table 400, described in below sections) to identify which of the selected tasks are completed or partially completed. The determination may be performed based on a status and/or percentage of completion maintained (as part of the management data) for each task. According to aspects of the present disclosure, tasks identified as being completed (fully) or the completed portions of partially completed tasks are not shifted along the timeline.

Thus, management tool 150 identifies that tasks T01 is completed fully and accordingly excludes the task T01 from the group of tasks to be shifted. Management tool 150 also identifies that task T02 is a partially completed task. In response, management tool 150 first forms new tasks T02a and T02b for the partially completed task T02, where task T02a representing the already completed portion of the task T02 and task T02b representing the non-completed portion of the task T02. Management tool 150 then includes the tasks T02a and T02b in the place of task T02 along the timeline, and also includes the non-completed task T02b in the place of the original selected task T02 in the group of tasks.

Management tool 150 may similarly exclude other fully completed tasks from the group and include non-completed portions of the tasks corresponding to other partially completed tasks in the group. Management tool 150 then computes the new start and end values for (the start and end times of) each of the tasks in the final group of tasks to be shifted as described in detail below.

As noted above, the offset received may indicate the number of days or hours by which each of the tasks are to be shifted or a new start value for the earliest (according to the original values) task in the group of tasks. In the scenario that a new start value for the earliest task is specified, management tool 150 calculates the difference between the new start value and the original start value of the earliest task. It should be noted that a positive value for the offset/difference indicates that the tasks are to be delayed (done later than the original time), while a negative value indicates that the tasks are to be advanced (done ahead of the original time).

Management tool 150 then computes the new (start and end) values for each selected tasks by adding the calculated difference or the offset (when received as a number) to the corresponding original values of each task. Thus, for task T02b (shown from 31-Jul to 1-Aug in FIG. 3A), the new start value is computed as 1-Aug (that is, 31-Jul added with 1 day, the offset specified by the user) and the new end value is computed as 2-Aug (that is, 1-Aug added with 1 day). Similarly the new start and end values for each of the tasks T03 and T04 (the other tasks in the selected group) is computed based on the original (start and end) values and the specified offset of 1 day.

According to an aspect of the present disclosure, management tool 150 computes the new values for a task based on the availability of the resource assigned to the task while ensuring that the effort required for completing the task remains the same (before and after the shifting of the task). Thus, if a task requires an additional effort of 2 days to complete the task, management tool 150 ensures that the additional effort remains the same 2 days for the task after shifting. In one embodiment, management tool 150 computes the new values for the start and end times of a task taking into consideration the common non-working days (such as Saturday and Sunday) and the specific non-working days of the resource assigned to the task. In general, the computation of the new values is based on the project work calendar (indicating the common non-working days) and the resource work calendars corresponding to different resources.

In the above example, management tool 150 determines that for task T02b, the new end value of 2-Aug is a non-working day for the resource “Harry” (assigned to the task), and accordingly changes the new end value to 3-Aug (which is a Saturday), then to 4-Aug (which is a Sunday) and finally to 5-Aug (a working day). It may be observed that the additional effort to completing the task T02b remains the same 2 days after the final new start and end values are computed.

Management tool 150 also ensures that any relationships/ dependencies existing among the group of tasks is preserved (not violated) by the computed new values for the start and end times of the tasks. In one embodiment, only the dependencies (such as 331) that are already satisfied by the original start and end values are preserved after the shifting. Any dependencies (such as 332) that are not satisfied (violated) by the original values and any dependencies (such as 333) existing between a selected task and a non-selected task (not being shifted) are not preserved after the shifting.

In the above example, only the Finish-to-Start dependency 331 between the tasks T02 and T03 is preserved during the shifting. In other words, management tool 150 computes the new start and end values for the task T03 based on the received offset (1 day) and the newly computed start and end value of task T02b (which corresponds to task T02 after shifting). Thus, management tool 150 computes the new start and end values of tasks T03 as being 6-Aug (1 day after the end of task T02b), thus ensuring that the Finish-to-Start dependency 331 between the tasks is preserved after the shifting.

After computing all the corresponding new start and end values for each of the tasks in the final group of tasks (formed from the selected group and after performing the necessary exclusions and inclusions), management tool 150 sets the start and end times of each of the tasks to the corresponding computed new values. After setting the values, management tool 150 then updates (resends for display) the timeline with the new computed times for the final group of tasks. The manner in which such update is done and the corresponding timeline is displayed to the user/manager is described below with examples.

### 6. Updating Display of Timeline

Referring to FIG. 3B, display area 340 provides a timeline of the various tasks in the project after the shifting of a group of tasks along the timeline. In particular, the timeline displays the result of updating various existing/new tasks after a request to shift the tasks T01, T02, T03 and T04 by an offset of a day has been processed by management tool 150.

In display area 340, it may be observed that task T01 has not been shifted due to the task having been fully completed (and according excluded from the group). Partially completed task T02 is not shown in the timeline, and instead task T02a (display area 351) representing the already completed portion of task T02 and task T02b (display area 352) representing the non-complete portion of task T02 are shown. Task T02b is shown extending from 1-Aug to 5-Aug due to the three intervening days being non-working days for the assigned resource “Harry”. Task T03 (display area 355) is shown scheduled at 6-Aug to preserve the Finish-to-Start dependency 331. It may be further observed that dependency 333 is shown as being violated after the shifting of task T04 by a day. However, no additional computation/scheduling are performed since dependency 333 is between a selected task T04 that is shifted and a non-selected task T05 that is not shifted.

Thus, a user/administrator, using the interfaces of FIGS. 3A and 3B, is facilitated to shift a desired group of tasks by a desired offset. As noted above, such shifting is performed without any additional overheads to the user/administrator or associated with the execution of the scheduler application.

According to an aspect of the present disclosure, a user/manger is enabled to additionally specify (using the interfaces described with respect to FIG. 3A), a copy flag to indicate that a copy of the selected/received group of tasks is to be added. In response to the specification of the copy flag, management tool 150 adds a new group of tasks (which is a copy of the received group of tasks), and then performs the computing and setting steps noted above for the new group of tasks. Thus, the start and end times of each of the new group of tasks is set respectively to the new start and end values computed based on the received offset and the original start and end values of the received group of tasks. Management tool 150 then updates the display of the timeline such that both the received group of tasks and the new group of tasks are present on the timeline.

Referring to FIG. 3C, display area 340 provides a timeline of the various tasks in the project after the copying of a group of tasks along the timeline. In particular, the timeline displays the result of updating various existing/new tasks after a request to shift the tasks T01, T02, T03 and T04 by an offset of 7 days along with a copy flag has been processed by management tool 150.

Thus, in response to the copy flag, management tool 150 adds a copy of the original tasks T01, T02, T03 and T04 as corresponding new tasks T11, T12, T13 and T14 at the received/user specified offset of 7 days. It may be observed that all the tasks including completed and partially completed tasks are copied to the new offset. In addition, management tool 150 also copies any dependencies existing among the received group of tasks. Accordingly, dependencies 331 (between T02 and T03) and 332 (between T02 and T04) are shown copied as corresponding dependencies 371 (between T12 and T13) and 372 (between T12 and T14). However, dependency 333 between a copied task T04 and a non-copied task T05 is shown as being not copied.

Thus, a user/administrator, using the interfaces of FIGS. 3A and 3C, is facilitated to copy a desired group of tasks by a desired offset. In one embodiment, the user may also indicate that the new set of tasks needs to reflect the percentage of completion of the original tasks. Referring to FIG. 3D, display area 380 is similar to display area 360 and provides a timeline of the various tasks in the project after the copying of a group of tasks T01, T02, T03 and T04 by an offset of 7 days. It may be observed that tasks T11 and T12 reflect the percentage of completion of the corresponding original tasks T01 and T02.

The description is continued illustrating the manner in which management data (noted above) may be maintained in one embodiment.

### 7. Management Data

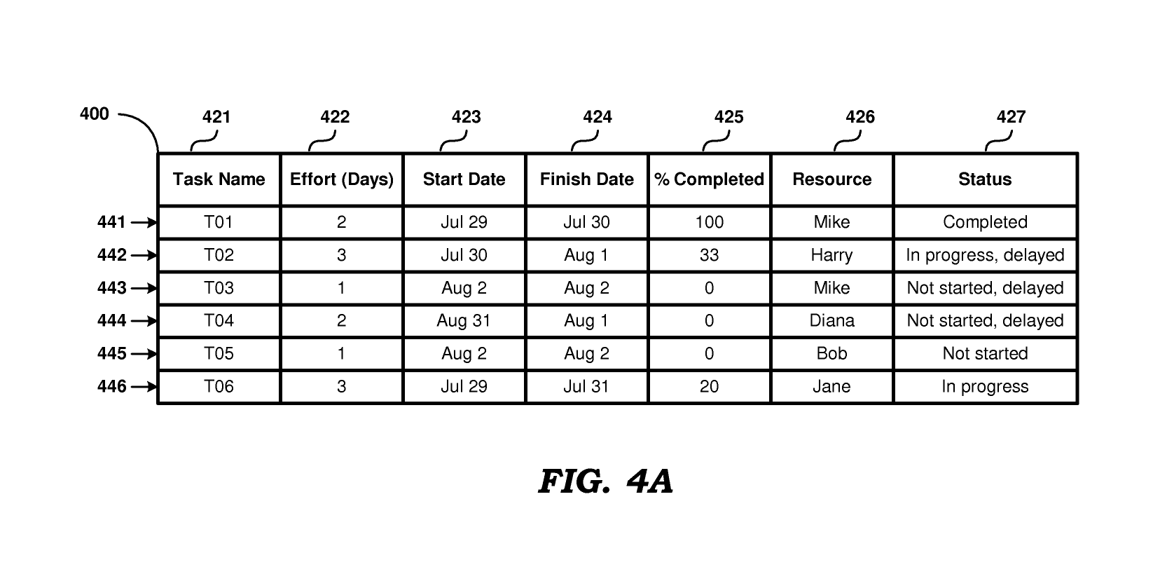

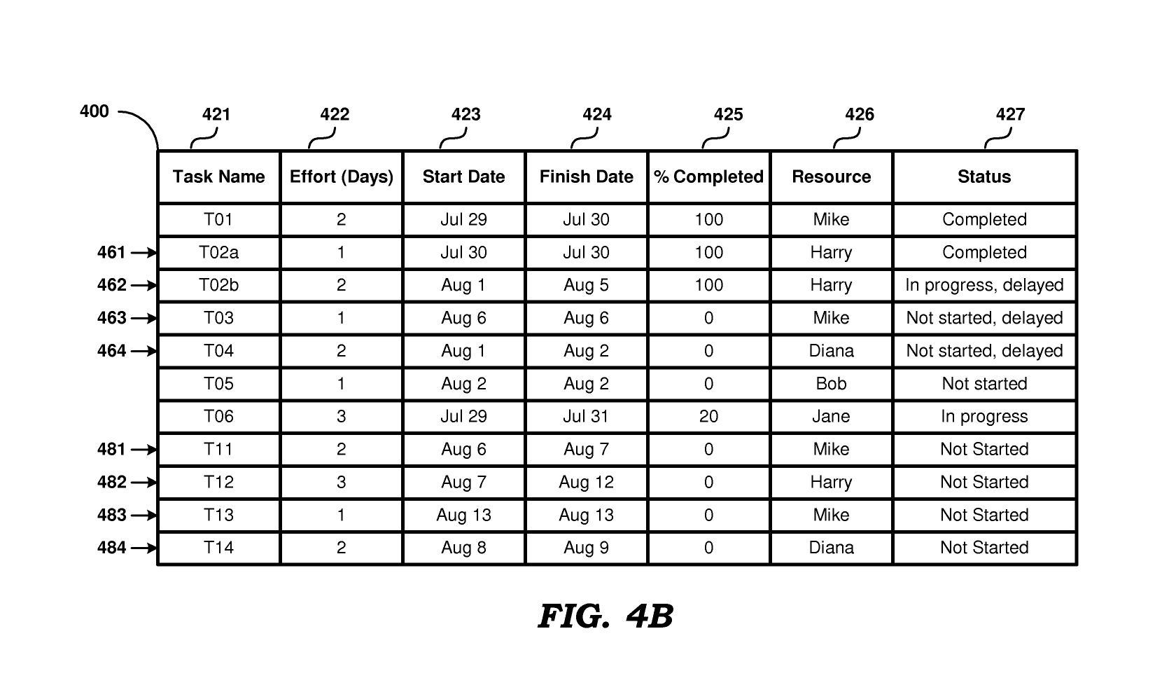

FIGS. 4A and 4B together illustrates the manner in which management data is maintained in one embodiment. For illustration, it is assumed that data store 120 is implemented as a database server and accordingly the management data is maintained in the form of table 400 in a database in the database server. However, in alternative embodiments, the management data may be maintained in any other format such as XML (Extensible Markup Language), as will be apparent to one skilled in the relevant arts by reading the disclosure herein.

Referring to FIG. 4A, table 400 depicts a portion of management data maintained in data store 120. Column 421 (“Task Name”) specifies a unique identifier for each task. Columns 422 (“Effort (Days)”) and 425 (“% completion”) respectively specifies the total effort in days allocated for each task and the percentage of completion of the task. The effort required to completing each task can be calculated using the total effort and the percentage completion as will be apparent to one skilled in the relevant arts. Columns 423 (“Start Date”) and 424 (“Finish Date”) specifies the corresponding start and end time instances (in particular, the dates) for each task. Column 426 (“Resource”) specifies the name of the resource assigned to each task. Column 427 (“Status”) specifies the current status of each task. In particular, the status indicates whether a task is completed, in progress or has not started along with an indication of whether the task has been delayed.

Each of rows 441-446 specifies the details of a corresponding task represented in the timeline. In particular, row 441 specifies that the task named T01 requires a total effort of 2 days, starts from “Jul 29” and ends on “Jul 30” , is assigned to resource “Mike”, the percentage of completion is 100 and the status is “Completed”. Similarly the other rows specify the details of other tasks (T02 through T06) shown in display area 300 of FIGS. 3A-3D.

Thus, the management data is maintained in the form of table 400 in a database in data store 120. Though not shown, dependency data indicating the dependencies among the tasks of table 400 may be similarly specified, for example as another column in table 400 or as another table in the database. In general, the management data is maintained by project/task management applications executing in server system 130, with management tool 150 accessing/updating the data via the project/task management application executing in server system 130.

Management tool 150 inspects the data of table 400 to identify the completed tasks (column 427), the percentage of completion of each task (column 425), the effort required for completing each task (columns 422 and 425), and the values for the start and end times for each of the tasks (columns 423 and 424). In response to receiving a request to shift a group of tasks, management tool 150 may modify the corresponding values (from the original values to the computed new values) in columns 423 and 424 to effect the shifting of the tasks. Management tool 150 may also add additional rows in response to identifying that a partially completed task (such as T02) is present in the group of tasks sought to be shifted.

Referring to FIG. 4B, rows 461-464 illustrate the changes made to table 400 by management tool 150 after processing of a request to shift a group of tasks containing T01, T02, T03 and T04 by an offset of a day. It may be observed that rows 461 and 462 corresponding to the completed and non-completed portions of task T02 has been newly added in place of row 442 of FIG. 4A. Rows 463 and 464 indicate the updates in the start and end date columns (423 and 424) after the shifting of the tasks T03 and T04. It may be further observed that the details of the tasks not selected in the group (such as T05 and T06) are not changed by management tool 150.

In response to the copy flag, management tool 150 adds additional rows (e.g., corresponding to tasks T11 to T14) to table 400 to effect the copying of the tasks (and accordingly cause the display of FIG. 3C). In addition, management tool 150 may copy the values in column 425 of the original rows to the newly added row, thereby causing the newly added tasks to reflect the percentage of completion of the original tasks. Referring to FIG. 4B, rows 481-484 correspond to the new tasks T11-T14 added by management tool 150 after processing a request to copy the tasks T01-T04 by an offset of 7 days. It may be observed that the percentage completed (column 425) for each of new tasks T11-T14 is shown to be 0 and the corresponding status (column 427) indicates “Not Started”.

However, as noted above with respect to FIG. 3D, a user may also indicate that the new set of tasks (a copy of the selected groups of tasks) needs to reflect the percentage of completion of the original tasks. In response, management tool 150 may copy the values in columns 425 from the previous rows (441-444) corresponding to the selected group of tasks to the new rows (481-484) corresponding to the new set of tasks.

In one embodiment, management tool 150 enforces that the percentages of tasks that are completed, in progress and not started remain the same before and after the above noted copying (of FIG. 3D). Such enforcing may be required for example for demonstrating the operation of a scheduling engine in a project/task management system. For example, it may be required that the scheduling be demonstrated on two different dates for a same pattern of tasks (e.g. T01-T04), with the tasks being shown at a future date with respect to the demonstration date. As such, the copying of the same group of tasks while enforcing the percentages noted above, facilitates the same pattern to be duplicated at different future dates (by specifying appropriate offsets). Such copying relieves the user from manually recreating the pattern of tasks at each of the future dates.

It should be appreciated that the features described above can be implemented in various embodiments as a desired combination of one or more of hardware, executable modules, and firmware. The description is continued with respect to an embodiment in which various features are operative when executable modules are executed.

### 8. Digital Processing System

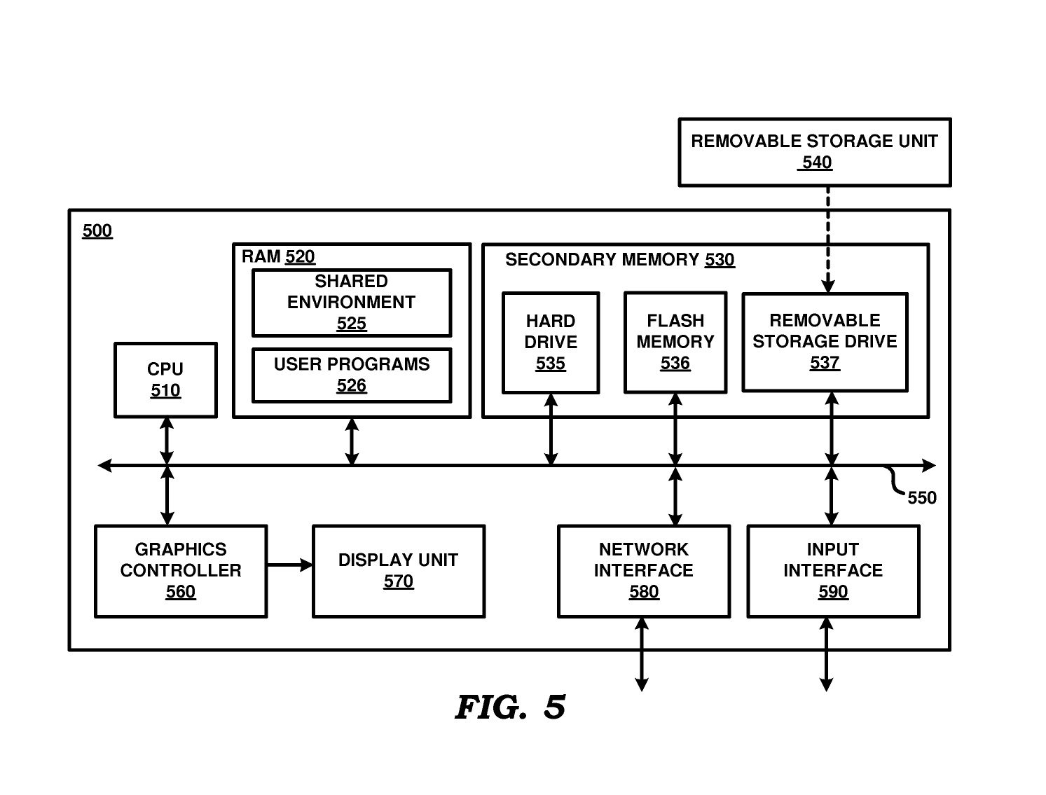

FIG. 5 is a block diagram illustrating the details of digital processing system 500 in which various aspects of the present disclosure are operative by execution of appropriate executable modules. Digital processing system 500 may correspond to management tool 150.

Digital processing system 500 may contain one or more processors such as a central processing unit (CPU) 510, random access memory (RAM) 520, secondary memory 530, graphics controller 560, display unit 570, network interface 580, and input interface 590. All the components except display unit 570 may communicate with each other over communication path 550, which may contain several buses as is well known in the relevant arts. The components of FIG. 5 are described below in further detail.

CPU 510 may execute instructions stored in RAM 520 to provide several features of the present disclosure. CPU 510 may contain multiple processing units, with each processing unit potentially being designed for a specific task. Alternatively, CPU 510 may contain only a single general-purpose processing unit.

RAM 520 may receive instructions from secondary memory 530 using communication path 550. RAM 520 is shown currently containing software instructions constituting operating environment 525 and/or other user programs 526 (such as the instances of task management software, etc.). In addition to operating environment 525, RAM 520 may contain other software programs such as device drivers, virtual machines, etc., which provide a (common) run time environment for execution of other/user programs.

Graphics controller 560 generates display signals (e.g., in RGB format) to display unit 570 based on data/instructions received from CPU 510. Display unit 570 contains a display screen to display the images defined by the display signals. Each of the displays shown in FIGS. 3A-3D corresponds to an image screen displayed at corresponding time duration on the display screen. Input interface 590 may correspond to a keyboard and a pointing device (e.g., touch-pad, mouse) and may be used to provide inputs (such as those provided by the managers of the enterprise using the interfaces of FIGS. 3A-3D as described above). Network interface 580 provides connectivity to a network (e.g., using Internet Protocol), and may be used to communicate with other systems connected to the network (such as end user systems 160A-160X, server system 130, etc.).

Secondary memory 530 may contain hard drive 535, flash memory 536, and removable storage drive 537. Secondary memory 530 may store the data (for example, portions of the data shown in FIG. 4, the data entered by an manager in the interfaces of FIGS. 3A-3D, etc.) and software instructions (for implementing the steps of FIG. 2), which enable digital processing system 500 to provide several features in accordance with the present disclosure. The code/instructions stored in secondary memory 530 may either be copied to RAM 520 prior to execution by CPU 510 for higher execution speeds, or may be directly executed by CPU 510.

Secondary memory 530 may contain hard drive 535, flash memory 536, and removable storage drive 537. Some or all of the data and instructions may be provided on removable storage unit 540, and the data and instructions may be read and provided by removable storage drive 537 to CPU 510. Removable storage unit 540 may be implemented using medium and storage format compatible with removable storage drive 537 such that removable storage drive 537 can read the data and instructions. Thus, removable storage unit 540 includes a computer readable (storage) medium having stored therein computer software and/or data. However, the computer (or machine, in general) readable medium can be in other forms (e.g., non-removable, random access, etc.).

In this document, the term “computer program product” is used to generally refer to removable storage unit 540 or hard disk installed in hard drive 535. These computer program products are means for providing software to digital processing system 500. CPU 510 may retrieve the software instructions, and execute the instructions to provide various features of the present disclosure described above.

The term “storage media/medium” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage memory 530. Volatile media includes dynamic memory, such as RAM 520. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 550. Transmission media can also take the form of acoustic or light waves, such as those generated during radio-wave and infra-red data communications.

Reference throughout this specification to “one embodiment”, “an embodiment”, or similar language means that a particular feature, structure, or characteristic described in connection with the embodiment is included in at least one embodiment of the present disclosure. Thus, appearances of the phrases “in one embodiment”, “in an embodiment” and similar language throughout this specification may, but do not necessarily, all refer to the same embodiment.

Furthermore, the described features, structures, or characteristics of the disclosure may be combined in any suitable manner in one or more embodiments. In the above description, numerous specific details are provided such as examples of programming, software modules, user selections, network transactions, database queries, database structures, hardware modules, hardware circuits, hardware chips, etc., to provide a thorough understanding of embodiments of the disclosure.

### 9. Conclusion

While various embodiments of the present disclosure have been described above, it should be understood that they have been presented by way of example only, and not limitation. Thus, the breadth and scope of the present disclosure should not be limited by any of the above-described exemplary embodiments, but should be defined only in accordance with the following claims and their equivalents.

It should be understood that the figures and/or screen shots illustrated in the attachments highlighting the functionality and advantages of the present disclosure are presented for example purposes only. The present disclosure is sufficiently flexible and configurable, such that it may be utilized in ways other than that shown in the accompanying figures.

Further, the purpose of the following Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the present disclosure in any way.

What is claimed is:

1. A method of facilitating scheduling of tasks, said method comprising:
sending a plurality of tasks for display along a timeline, each of said plurality of tasks having a start time and an end time, said start time and said end time respectively equaling a original start value and a original end value along said timeline;
receiving data indicating a group of tasks and an offset, said groups of tasks being contained in said plurality of tasks;
computing, for each task of said group of tasks, a new start value and a new end value for the task based on said offset;
setting for each task of said group of tasks, said start time and said end time of the task respectively to said new start value and said new end value; and
updating the display of said plurality of tasks along said timeline, wherein said start time and said end time of each task of said group of tasks is according to said setting.

2. The method of claim 1, wherein a first task of said plurality of tasks is not contained in said group of tasks, wherein said updating is not performed for said first task upon receipt of said data indicating said group of tasks.

3. The method of claim 2, further comprising:
maintaining a management data specifying for each of said plurality of tasks, a corresponding effort required to completing the task and a corresponding resource of a plurality of resources assigned to the task, wherein said management data also indicates the availability of each of said plurality of resources,
wherein said computing computes said new start value and said new end value for each task based on said offset and the availability of the resource assigned to the task, while ensuring that the effort for the task remains the same as that before said computing.

4. The method of claim 3, wherein said management data further indicates whether or not each of said plurality of tasks is completed, said method further comprising:
inspecting, after said receiving, said management data to identify that a second task of said group of tasks is already completed;
excluding said second task from said group of tasks,
wherein said setting and said updating are not performed for said second task.

5. The method of claim 4, wherein said management data indicates a percentage of completion of each of said plurality of tasks, wherein said inspecting identifies that a third task of said group of tasks is partially completed by examining said percentage of completion in said management data, said method further comprising:
forming a fourth task and a fifth task respectively representing the completed and non-completed portions of said third task; and
including said fourth task and said fifth task in place of said third task in said plurality of tasks, wherein said including also includes said fifth task in place of said third task in said group of tasks,
wherein said setting and said updating are performed for said fifth task instead of said third task.

6. The method of claim 5, wherein said updating includes both of said fourth task and said fifth task, but does not include said third task, in the display.

7. The method of claim 3, wherein said management data further indicates the dependencies among said plurality of tasks, wherein said inspecting identifies a dependency between a sixth task and a seventh task, said sixth task and said seventh task being contained in said group of tasks,
wherein said computing, in view of said dependency, said new start value and said new end value for said sixth task based on said offset and at least one of said new start value and said new end value of said seventh task according to said dependency.

8. The method of claim 3, further comprising:
receiving second data indicating a second group of tasks, a second offset and a copy flag, said second group of tasks being contained in said plurality of tasks, wherein said copy flag indicates that a copy of said second group of tasks is to be scheduled;
adding to said plurality of tasks, a third group of tasks representing a copy of said second group of tasks;
computing, for each task of said third group of tasks, a new start value and a new end value for the task based on the original start values and original end values of said second group of tasks, and said offset;
setting for each task of said third group of tasks, said start time and said end time of the task respectively to said new start value and said new end value; and
updating the display of said plurality of tasks including said third group of tasks along said timeline, wherein said start time and said end time of each task of said third group of tasks is according to said setting, wherein both of said second group of tasks and said third group of tasks are displayed along said timeline.

9. A non-transitory machine readable medium storing one or more sequences of instructions for enabling a system to facilitate scheduling of tasks, wherein execution of said one or more instructions by one or more processors contained in said system enables said system to perform the actions of:
sending a plurality of tasks for display along a timeline, each of said plurality of tasks having a start time and an end time, said start time and said end time respectively equaling a original start value and a original end value along said timeline;
receiving data indicating a group of tasks and an offset, said groups of tasks being contained in said plurality of tasks;
computing, for each task of said group of tasks, a new start value and a new end value for the task based on said offset;
setting for each task of said group of tasks, said start time and said end time of the task respectively to said new start value and said new end value; and
updating the display of said plurality of tasks along said timeline, wherein said start time and said end time of each task of said group of tasks is according to said setting.

10. The machine readable medium of claim 9, wherein a first task of said plurality of tasks is not contained in said group of tasks, wherein said updating is not performed for said first task upon receipt of said data indicating said group of tasks.

11. The machine readable medium of claim 10, further comprising one or more instructions for:
maintaining a management data specifying for each of said plurality of tasks, a corresponding effort required to completing the task and a corresponding resource of a plurality of resources assigned to the task, wherein said management data also indicates the availability of each of said plurality of resources,
wherein said computing computes said new start value and said new end value for each task based on said offset and the availability of the resource assigned to the task, while ensuring that the effort for the task remains the same as that before said computing.

12. The machine readable medium of claim 11, wherein said management data further indicates whether or not each of said plurality of tasks is completed, said method further comprising one or more instructions for:
inspecting, after said receiving, said management data to identify that a second task of said group of tasks is already completed;
excluding said second task from said group of tasks,
wherein said setting and said updating are not performed for said second task.

13. The machine readable medium of claim 12, wherein said management data indicates a percentage of completion of each of said plurality of tasks, wherein said inspecting identifies that a third task of said group of tasks is partially completed by examining said percentage of completion in said management data, said method further comprising one or more instructions for:
forming a fourth task and a fifth task respectively representing the completed and non-completed portions of said third task; and
including said fourth task and said fifth task in place of said third task in said plurality of tasks, wherein said including also includes said fifth task in place of said third task in said group of tasks,
wherein said setting and said updating are performed for said fifth task instead of said third task.

14. The machine readable medium of claim 11, wherein said management data further indicates the dependencies among said plurality of tasks, wherein said inspecting identifies a dependency between a sixth task and a seventh task, said sixth task and said seventh task being contained in said group of tasks,
wherein said computing, in view of said dependency, said new start value and said new end value for said sixth task based on said offset and at least one of said new start value and said new end value of said seventh task according to said dependency.

15. The machine readable medium of claim 11, further comprising one or more instructions for:
receiving second data indicating a second group of tasks, a second offset and a copy flag, said second group of tasks being contained in said plurality of tasks, wherein said copy flag indicates that a copy of said second group of tasks is to be scheduled;
adding to said plurality of tasks, a third group of tasks representing a copy of said second group of tasks;
computing, for each task of said third group of tasks, a new start value and a new end value for the task based on the original start values and original end values of said second group of tasks, and said offset;
setting for each task of said third group of tasks, said start time and said end time of the task respectively to said new start value and said new end value; and
updating the display of said plurality of tasks including said third group of tasks along said timeline, wherein said start time and said end time of each task of said third group of tasks is according to said setting, wherein both of said second group of tasks and said third group of tasks are displayed along said timeline.

16. A digital processing system comprising:
a processor;
a random access memory (RAM);
a machine readable medium to store one or more instructions, which when retrieved into said RAM and executed by said processor causes said digital processing system to facilitate scheduling of tasks, said digital processing system performing the actions of:
sending a plurality of tasks for display along a timeline, each of said plurality of tasks having a start time and an end time, said start time and said end time respectively equaling a original start value and a original end value along said timeline;
receiving data indicating a group of tasks and an offset, said groups of tasks being contained in said plurality of tasks;
computing, for each task of said group of tasks, a new start value and a new end value for the task based on said offset;
setting for each task of said group of tasks, said start time and said end time of the task respectively to said new start value and said new end value; and
updating the display of said plurality of tasks along said timeline, wherein said start time and said end time of each task of said group of tasks is according to said setting.

17. The digital processing system of claim 16, wherein a first task of said plurality of tasks is not contained in said group of tasks, wherein said digital processing system does not perform said updating for said first task upon receipt of said data indicating said group of tasks.

18. The digital processing system of claim 17, further performing the actions of:
maintaining a management data specifying for each of said plurality of tasks, a corresponding effort required to completing the task and a corresponding resource of a plurality of resources assigned to the task, wherein said management data also indicates the availability of each of said plurality of resources,
wherein said digital processing system computes said new start value and said new end value for each task based on said offset and the availability of the resource assigned to the task, while ensuring that the effort for the task remains the same as that before said computing.

19. The digital processing system of claim 18, wherein said management data further indicates the dependencies among said plurality of tasks, wherein said inspecting identifies a dependency between a sixth task and a seventh task, said sixth task and said seventh task being contained in said group of tasks,
wherein said digital processing system, in view of said dependency, computes said new start value and said new end value for said sixth task based on said offset and at least one of said new start value and said new end value of said seventh task according to said dependency.

20. The digital processing system of claim 18, further performing the actions of:
receiving second data indicating a second group of tasks, a second offset and a copy flag, said second group of tasks being contained in said plurality of tasks, wherein said copy flag indicates that a copy of said second group of tasks is to be scheduled;
adding to said plurality of tasks, a third group of tasks representing a copy of said second group of tasks;
computing, for each task of said third group of tasks, a new start value and a new end value for the task based on the original start values and original end values of said second group of tasks, and said offset;
setting for each task of said third group of tasks, said start time and said end time of the task respectively to said new start value and said new end value; and
updating the display of said plurality of tasks including said third group of tasks along said timeline, wherein said start time and said end time of each task of said third group of tasks is according to said setting, wherein both of said second group of tasks and said third group of tasks are displayed along said timeline.
